(19) United States
(12) Patent Application Publication
(10) Pub. No.: US 2005/0271556 A1
(43) Pub. Date: Dec. 8, 2005

(54) Analytical vessel and trace element analysis method

(76) Inventors: Miyuki Takenaka, Yokohama-shi (JP); Motonaka Yabuki, Naka-gun (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/127,268

(22) Filed: May 12, 2005

(30) Foreign Application Priority Data
May 13, 2004 (JP) 2004-144025

(51) Int. Cl. B01L 3/00

(52) U.S. Cl. 422/102

(57) ABSTRACT

An analytical vessel for analyzing trace elements, which is formed of glassy carbon produced through carbonization of a resin composition. A method of analyzing trace elements, which comprises the steps of introducing a solution which is capable of decomposing an assay sample into an analytical vessel containing the assay sample and made of glassy carbon produced through carbonization of a resin composition to thereby dissolve the assay sample, thus obtaining a sample solution; and measuring trace elements included in the assay sample and dissolved in the sample solution.

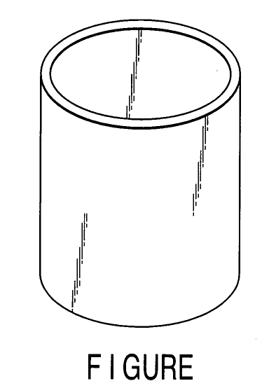

### CROSS-REFERENCE TO RELATED APPLICATIONS

This application is based upon and claims the benefit of priority from prior Japanese Patent Application No. 2004-144025, filed May 13, 2004, the entire contents of which are incorporated herein by reference.

### BACKGROUND OF THE INVENTION

1. Field of the Invention

The present invention relates to an analytical vessel and to a trace element analysis method.

2. Description of the Related Art

As for the means for analyzing and assessing the quantity of trace metallic impurities in a high-purity material such as a semiconductor device, there are known methods such as inductively coupled plasma-mass spectroscopy (ICP-MS) and graphite furnace atomic absorption spectroscopy (ETAAS). According to these methods, analysis of metallic impurities is performed by decomposing a sample into solution. The dissolution of the sample is performed by a process wherein a sample decomposer chemical (acid, for example) is introduced into a vessel accommodating the sample and then, pressure and/or heating are applied to the sample. This process is a pretreatment for analyzing the sample.

However, there are many possibilities in the process of decomposing the sample that a metallic impurity of the same kind as the metal to be analyzed may be permitted to exist in advance on the surface of the vessel (hereinafter referred to as the analytical vessel) to be employed in the pretreatment of analysis and hence may be permitted to elute into the sample, and that a metal in the previous sample may be permitted to remain on the surface of the analytical vessel due to repeated employment of the analytical vessel or a substance such as acid that has been employed in the washing of the analytical vessel after previous analysis may be permitted to remain on the surface of the analytical vessel and hence permitted to enter into the dissolved sample. Since these substances may be the same kind of element as the metallic impurity to be analyzed or may be a component that will obstruct the analysis, there will be raised various problems that the background of a measured value may be caused to increase, or the detection of substances to be analyzed may be obstructed, thereby badly hindering the performance of trace element analysis.

As a technique for overcoming the aforementioned problems, Japanese Laid-open Patent Publication (Kokai) No. 2001-247627 discloses a method wherein a fluororesin is employed for the fabrication of the analytical vessel. This method is directed to the enhancement of purity of the fluororesin itself constituting the analytical vessel, to improve the washing method of the analytical vessel and the surface treatment of the analytical vessel, thereby minimizing the quantity of substances that may increase the background of a measured value.

However, if an analytical vessel which is made of fluororesin is employed in the measurement of metallic impurities on the surface of a silicon wafer for example, the detection limit would be at most of the order of 100 to 1000 fg/cm². In view of the current situation where semiconductor devices are still desired to be improved in reliability much more, there is an increasing demand for analytic instruments more excellent in purity. Further, fluororesin is also accompanied by various kinds of problems that contaminants in the air can be easily entrapped through electrostatic force by the fluororesin, that due to the porosity of the fluororesin, gaseous substances are liable to be left in the fluororesin, and that a large quantity of acid is required for removing residual metals on the surface of the fluororesin.

On the other hand, there is known a glassy carbon as a material provided with not only the properties of fluororesin but also the properties of quartz, i.e., excellent in impermeability to gas and liquid, excellent in corrosion resistance, low in heat deformation, excellent in heat resistance, high in thermal conductivity and high in purity.

Generally, an analytical vessel for handling liquids such as acids is required to have, in addition to impermeability to liquid, a smooth surface, as low a porosity as possible, and absence of surface roughness that may be caused due to the generation of open pores. It is considered that glassy carbon has all of these properties.

Japanese Laid-open Patent Publication (Kokai) No. 2002-160969 discloses a method of manufacturing glassy carbon wherein used glassy carbon parts are utilized. According to this method, a used glassy carbon article is pulverized and sieved to obtain glassy carbon particles having a particle diameter of less than 800 μm, which are then kneaded with thermosetting resin and a solvent to obtain a resinous mixture. This resinous mixture is heat-cured until it becomes hard enough to be released from a mold, thereby obtaining a thermosetting resin. A molded article made of this thermosetting resin is then baked at a temperature of 800° C. or more in an inert gas atmosphere to manufacture glassy carbon.

However, when an analytical vessel is manufactured using glassy carbon that has been produced by making use of used glassy carbon parts as described above, the quantity of elements eluted from the vessel itself or the quantity of elements remaining in the vessel is not sufficiently low relative to the quantity of metallic impurities to be analyzed, thus increasing the background of measured values and hence making it difficult to realize precise analysis.

### BRIEF SUMMARY OF THE INVENTION

It is an object of the present invention to provide an analytical vessel which can be employed repeatedly for the analysis of impurities such as metallic impurities in a sample.

It is another object of the present invention to provide a method of analyzing trace elements using the aforementioned analytical vessel.

According to a first aspect of the present invention, there is provided an analytical vessel for analyzing trace elements, which is formed of glassy carbon produced through carbonization of a resin composition.

According to a second aspect of the present invention, there is provided a method of analyzing trace elements, which comprises preparing an analytical vessel containing an assay sample, the vessel made of glassy carbon produced through carbonization of a resin composition; introducing a solution which is capable of dissolving the assay sample into the analytical vessel to thereby dissolve the assay sample, thus obtaining a sample solution; and measuring trace elements dissolved in the sample solution.

### BRIEF DESCRIPTION OF THE SEVERAL VIEWS OF THE DRAWING

The single FIGURE is a perspective view showing an example of an analytical vessel for analyzing trace elements according to one embodiment of the present invention.

### DETAILED DESCRIPTION OF THE INVENTION

It has been found and confirmed by the present inventors that glassy carbon can be hardly contaminated with various kinds of elements (hereinafter referred to as impurities) such as Al, B, Ca, Co, Cr, Cu, Fe, Ge, K, Mg, Mo, Na, Ni, Pb, Si, Sr, Ti, Zn and Zr, and that when this glassy carbon is employed as a material of an analytical vessel for analyzing impurities, it is possible, even if the analytical vessel is repeatedly used, to extremely minimize the background (or noise in analysis) that may be caused to generate due to the previous analysis. The present invention has been accomplished based on this finding.

The analytical vessel for analyzing trace elements according to a first aspect of the present invention is formed of glassy carbon which can be produced through carbonization of a resin composition, as shown in FIGURE. This analytical vessel, having a dense and smooth surface, is capable of preventing external impurities from diffusing into the body of vessel even under high-temperature and high-pressure conditions, is capable of extremely suppressing impurities included in the body of vessel from eluting out of the body of vessel, and, since it is chemically inert, is capable of repeatedly having used for analyzing inorganic element such as metal in the sample.

As for the resin composition to be employed as a raw material, it is possible to employ a thermosetting resin such as a phenol resin, polyimide resin, epoxy resin, furan resin, or a mixture thereof. Since these resin compositions are least contaminated with impurity elements such as Al, B, Ca, Cr, Cu, Fe, Ge, K, Na, Ni, Si, Ti, etc., they are suitable for use in the manufacture of analytic vessel for the analysis of trace elements.

In this case, if the resin composition contains at least one element selected from the group consisting of Al, B, Ca, Cr, Cu, Fe, Ge, K, Na, Ni, Si, Ti, the content thereof should preferably be confined to 0.1 μg/g or less.

The carbonization of the resin composition can be performed by baking the resin composition in an inert gas atmosphere selected from argon gas and nitrogen gas at a temperature of not lower than 800° C., more preferably within the range of 1000 to 1400° C., most preferably at a temperature of 1200° C.

As for the specific method of carbonization of the resin composition, it is possible to employ the method described in Japanese laid-open Patent publication Nos. 7-69729 and 10-167826 incorporated herein by reference.

This carbonization can be performed on a molded body of vessel-like configuration which can be obtained through the molding of bulk material of the resin composition. Alternatively, the bulk material of the resin composition is carbonized at first and then the carbonized body may be made into a vessel-like configuration through cutting work. In view of minimizing the contamination with impurities, the former method is more preferable than the latter method.

The surface of the vessel should preferably be mirror-polished. Since the mirror-polished surface of glassy carbon is very dense and smooth, it is possible to effectively prevent the adsorption of impurities.

The analytical vessel for analyzing trace elements according to the first aspect of the present invention as explained above can be modified into the following embodiments where the limitation in quantity of impurities is variously defined.

1. A vessel which contains residual metal element of 100 fg/cm² or less, remained in the vessel, after a solution containing at least one metal element selected from the group consisting of Al, Cr, Cu, Fe, Mg, Zn and Zr at a concentration of 5% or less is placed in the vessel at a temperature ranging from 20 to 200° C. and then taken out of the vessel, and the vessel is washed.

2. A vessel which contains residual alkaline metal of 100 fg/cm² or less, eluted and remained in the vessel, after at least one alkaline solution selected from potassium hydroxide and sodium hydroxide each 5% or less in concentration is placed in the vessel at a temperature ranging from 20 to 200° C. and then taken out of the vessel, and the vessel is washed.

3. A vessel which contains residual ion of 1 ng/cm² or less, the residual ion being at least one residual ion selected from the group consisting of chloride ions, nitrate ions, bromide ions, sulfate ions and fluoride ions, and remained in the vessel, after an acid solution containing one acid selected from the group consisting of hydrochloric acid, nitric acid, hydrobromic acid, sulfuric acid and hydrofluoric acid at a concentration of 5% or less is placed in the vessel at a temperature ranging from 20 to 200° C. and then taken out of the vessel, and the vessel is washed.

4. A vessel which contains element of 100 fg/cm² or less, the element being at least one element selected from the group consisting of Al, B, Ca, Co, Cr, Cu, Fe, Ge, K, Mg, Mo, Na, Ni, Pb, Si, Sr, Ti, Zn and Zr, and eluted from the vessel, after at least one acid selected from the group consisting of hydrochloric acid, nitric acid, hydrobromic acid, sulfuric acid and hydrofluoric acid is placed in the vessel and then heated.

When the quantity of impurities mentioned above exceeds over the aforementioned upper limit in the aforementioned experiment of vessel, the vessel may not be said suitable for use as an analytical vessel for analyzing trace elements.

The method of analyzing trace elements according to the second aspect of the present invention is characterized in that it comprises of: introducing a solution which is capable of decomposing an assay sample into an analytical vessel containing the assay sample and made of glassy carbon produced through carbonization of a resin composition to thereby dissolve the assay sample, thus obtaining a sample solution; and measuring trace elements included in the assay sample and dissolved in the sample solution.

In this method of analyzing trace elements, the measurement of the trace element can be performed by means of inductively coupled plasma-mass spectroscopy, inductively coupled plasma-emission spectroscopy or graphite furnace atomic absorption spectroscopy.

Incidentally, as for the analytical vessel, those mentioned above can be employed.

When it is desired to employ, as an analytical vessel, a vessel which contains element of 100 fg/cm² or less, the element being at least one element selected from the group consisting of Al, B, Ca, Co, Cr, Cu, Fe, Ge, K, Mg, Mo, Na, Ni, Pb, Si, Sr, Ti, Zn and Zr, and eluted from the vessel, after at least one acid selected from the group consisting of hydrochloric acid, nitric acid, hydrobromic acid, sulfuric acid and hydrofluoric acid is placed in the vessel and then heated, it is possible to employ, as a solution for decomposing the assay sample, at least one acid solution selected from the group consisting of hydrochloric acid, nitric acid, hydrobromic acid, sulfuric acid and hydrofluoric acid to measure the quantity eluted (in the solution) of at least one trace element selected from the group consisting of Al, B, Ca, Co, Cr, Cu, Fe, Ge, K, Mg, Mo, Na, Ni, Pb, Si, Sr, Ti, Zn and Zr.

Next, one example of the analysis method employing the analytical vessel according one embodiment of the present invention will be explained. In this case, one example of measuring trace impurities (metals, etc.) remained on the surface of a semiconductor element will be explained.

First of all, a piece (having an area of about 1 cm²) of sample such as a silicon wafer is placed in a glassy carbon vessel (about 100 mL in capacity) to dissolve this sample. The dissolution of the sample can be performed as follows. Namely, about 10 mL of a solution consisting of a 1:1 mixture of nitric acid (30% in concentration) and hydrofluoric acid (25% in concentration) is introduced into an analytical vessel accommodating the sample. The analytical vessel is then subjected to heating for two hours at a temperature of 100° C. to dissolve the sample in the solution.

Then, 200 μL of sulfuric acid about 1% in concentration is introduced into the analytical vessel and the heating of the analytical vessel is continued until the white smoke of sulfuric acid is generated, thereby concentrating the solution in the analytical vessel. Then, pure water is added to the solution until the volume of the solution becomes 0.5 mL. This diluted solution (hereinafter referred to as dilute solution) is subjected to analysis using an analyzer such as ICP-MS, etc.

The trace analysis can be performed in this manner and the trace analysis of metals, etc., on the surface of semiconductor element is performed to determine that the quantity of impurities mentioned above is less than 100-1000 fg/cm².

For example, when the trace element analysis is repeated, there may be encountered with a case where the concentration of impurities included in the dilute solution is higher than the concentration of impurities included in the dilute solution which has been previously employed. In the case of the conventional analytical vessel, the impurities are liable to remain in the vessel, so that the residual impurities are permitted to enter into the dilute solution in the process of analysis, thereby increasing the background of measured value. Moreover, the washing of the analytical vessel has been very difficult. Since it is impossible, in the ordinary procedure of analysis, to distinguish the metal element being analyzed from the residual metal element that has been remained in advance in the analytical vessel, it has been very difficult to perform the analysis of trace impurity elements by making use of the conventional analytical vessel where residual impurities are more likely permitted to remain. Therefore, in the case of analytical vessel to be repeatedly employed, the vessel is required to have properties that the quantity of residual impurities to be left behind should be limited to 100 fg/cm² or less.

Further, in the employment of analytical vessel, a large quantity of acid is used for the dissolution of a sample or for the washing of impurities remained on the surface of the analytical vessel. However, when the quantity of metal elements is to be measured by means of ICP-MS, if chloride ions, bromide ions, sulfate ions or fluoride ions co-exist in addition to argon to be employed as a plasma gas, a spectral interference to the impurities is caused to generate due to the formation of each of the molecular ions, giving a great influence on the measurement.

Accordingly, the analytical vessel for use in trace element analysis is required to have characteristics, especially when the vessel is repeatedly used, that the quantity of residual chloride ions, nitrate ions, bromide ions, sulfate ions or fluoride ions in the vessel is limited to 100 ng/cm² or less.

In order to obtain a glassy carbon vessel which is suited for use in the analysis of trace elements, the present inventors have manufactured an analytical vessel as follows.

First of all, a resin block having a sufficiently large size as needed for specific application was subjected to cutting work to form a vessel, which was then baked in an inert gas to carbonize the vessel. This carbonized vessel was then polished to manufacture a glassy carbon molded article (100 mL in capacity) having a surface roughness (Ra) of about 0.1 μm.

This molded article thus obtained was immersed in concentrated nitric acid and heated for two days at a temperature of 100° C. to wash the molded article. Subsequently, the molded article was washed with pure water and immersed in 0.1 mol/L solution of nitric acid for two days, after which the molded article was washed again with pure water and dried to obtain an analytical vessel made of glassy carbon.

The analytical vessel thus obtained was smooth in surface and very low in porosity, and the surface of the analytical vessel was free from roughness. Therefore, this analytical vessel was provided with various properties suitable for use as an analytical vessel and further provided with characteristics that the possibility of leaving residual impurities on the surface of vessel can be minimized. Especially in the analysis of trace elements, the quantity of residual impurities to be left behind on the vessel should desirably be limited to 100 fg/cm² or less.

Furthermore, the analytical vessel thus obtained was provided with characteristics that the possibility of leaving behind the vapor of the acid employed in the dissolution of a sample or the possibility of leaving behind the acid employed in the washing of vessel can be minimized.

Since the analytical vessel made of glassy carbon and manufactured according to the method shown in this embodiment is featured in that the quantity of residual chloride ions, nitrate ions, bromide ions, sulfate ions or fluoride ions that may be left on the surface of the vessel can be minimized, it may be said that this analytical vessel is sufficiently provided with properties suitable for use as an analytical vessel for trace element analysis. Especially, in the trace element analysis, the quantity of residual chloride ions, bromide ions, sulfate ions or fluoride ions in the analytical vessel should desirably be limited to 1 ng/cm² or less. This limitation can be realized by reducing the quantity of impurities in the resin to be employed as a raw material.

Incidentally, in the case of the conventional analytical vessel, the same kind of component (metal element) as the impurity to be measured may be often permitted to elute from the vessel in the process of decomposing a semiconductor element in the measurement of the quantity of impurity in the semiconductor element for example. When the impurity that has been eluted from the conventional analytical vessel itself is permitted to enter into a dilute solution, the background of measured value would be caused to increase, thereby making it very difficult to perform the analysis.

For example, in the case where the impurity existing on the surface of semiconductor substrate is to be analyzed, if the quantity of the impurity eluted from the analytical vessel itself is in the range of around 100-1000 fg/cm², it may become difficult to identify if the element obtained from the analysis is the element eluted from the analytical vessel itself or the element derived from the semiconductor element. Accordingly, in the case of trace element analysis where an element around 100-1000 fg/cm² in quantity is to be measured, the quantity of impurity to be eluted from the analytical vessel itself should be limited to at most 100 fg/cm² or less.

The analytical vessel made of glassy carbon and manufactured according to the method shown in this embodiment is featured in that the quantity of impurities such as metals that have been eluted from the vessel itself can be minimized. Especially, in the trace element analysis, the quantity of impurities to be eluted from the analytical vessel itself should desirably be limited to 100 fg/cm² or less.

Further, according to the manufacturing method illustrated in this embodiment, since possibility of remaining of the solution adsorbed on the surface of the vessel is low, reliability of the measured values. Further, since it is no longer required to use various kinds of molds for analysis, the analytical vessel can be produced in a small-scale so that the analytical vessel can be manufactured as a consumable article, thus making it possible to reduce the manufacturing cost.

Incidentally, the analytical vessel may not be formed exclusively of glassy carbon as a material for the vessel as described above, but can be manufactured in such a manner that a vessel formed of refractory material capable of withstanding temperature ranging from 1000° C. to 1200° C. is employed as a base body, on the surface of which glassy carbon is deposited to cover the base body, thereby obtaining likewise an analytical vessel which is suited for trace element analysis.

As for the refractories, it is possible to employ a nitride such as Si₃N₄, AlN, BN, TaN and NbN; a carbide such as TaC, HfC, TiC, WC, SiC and B₄C; a boride W₂B, MO₃B₂, ZrB₂, TiB₂, HfB₂ and TaB₂; an oxide such as SiO₂, Al₂O₃ and ZrO₂; and silicide such as MoSi₂, WSi₂, Zr₃Si₃ and Ta₅Si₃. These materials can be formed into a three-dimensional vessel, on the surface of which a raw material of glassy carbon is coated and then baked in an inert gas atmosphere to carbonize it. Alternatively, on the surface of the three-dimensional vessel, glassy carbon is deposited to cover it by means of sputtering, thereby making it possible to obtain a vessel suited for use as a trace element analysis vessel.

Next, in order to evaluate the properties required for the trace element analytical vessel made of glassy carbon, the following experiments (1-5) and comparative experiments (1-16) were performed.

In the experiments (1-5), two vessels (vessel [A] and vessel [B]) differing in quantity of elements included in a resin employed as a raw material of glassy carbon were employed. In the comparative experiments (1-16), four kinds of vessels differing in kinds and particle diameter of powder of raw materials of polytetrafluoroethylene (hereinafter referred to as PTFE) and modified PTFE were employed.

The vessel (A) was manufactured from a raw resin containing not more than 0.1 μg/g of at least one element selected from the group consisting of Al, B, Ca, Cr, Cu, Fe, K, Na, Ni, Si and Ti. The vessel (B) was manufactured from a raw resin containing not more than 3.2 μg/g of at least one element selected from the group consisting of Al, B, Ca, Cr, Cu, Fe, K, Na, Ni, Si and Ti.

On the other hand, the PTFE vessels and the modified PTFE vessels were molded articles (available from Nippon Bulker Kogyo Co., Ltd.), wherein the PTFE vessels were manufactured using raw powder having a particle diameter of 300 μm or 20 μm, and the modified PTFE vessels were manufactured using raw powder having a particle diameter of 300 μm or 20 μm.

The vessel (A) and the vessel (B) were respectively formed through the cutting work of a resin block to obtain a vessel, which was then baked in an inert gas atmosphere to carbonize the vessel. This carbonized vessel was then polished to manufacture a glassy carbon molded article (100 mL in capacity) having a surface roughness (Ra) of about 0.1 μm. These molded articles thus obtained were respectively immersed in concentrated nitric acid and heated for two days at a temperature of 100° C. to wash the molded articles. Subsequently, these molded articles were respectively washed with pure water and immersed in 0.1 mol/L solution of nitric acid for two days, after which the molded articles were respectively washed again with pure water to obtain analytical vessels.

On the other hand, with respect to the PTFE vessels and the modified PTFE vessels, they were polished to obtain a surface roughness (Ra) of about 0.1 μm.

In the experiments 1-4, the vessel (A) was employed, and in the experiment 5, the vessel (B) was employed. In the comparative experiments 1-16, the PTFE vessels or the modified PTFE vessels were employed. The details thereof are as shown in the following Table 1.

TABLE 1

| | | | PTFE vessel | | Modified PTFE vessel | |
|---|---|---|---|---|---|---|
| | Glassy carbon vessel | | 300 μm raw | 20 μm raw | 300 μm raw | 20 μm raw |
| | Vessel (A) | Vessel (B) | powder | powder | powder | powder |
| Ex. 1 | Experiment 1 | — | Comp. | Comp. | Comp. | Comp. |
| | | | Experiment 1 | Experiment 2 | Experiment 3 | Experiment 4 |
| Ex. 2 | Experiment 2 | — | Comp. | Comp. | Comp. | Comp. |
| | | | Experiment 5 | Experiment 6 | Experiment 7 | Experiment 8 |
| Ex. 3 | Experiment 3 | — | Comp. | Comp. | Comp. | Comp. |
| | | | Experiment 9 | Experiment 10 | Experiment 11 | Experiment 12 |
| Ex. 4 | Experiment 4 | Experiment 5 | Comp. | Comp. | Comp. | Comp. |
| | | | Experiment 13 | Experiment 14 | Experiment 15 | Experiment 16 |

Note:
Vessel (A): Glassy carbon employed as a raw material contained not more than 0.1 μg/g of impurities.
Vessel (B): Glassy carbon employed as a raw material contained not more than 3.2 μg/g of impurities.
PTFE: Polytetrafluoroethylene.

The acid employed in each example was an ultrahigh purity reagent where the concentration of the element to-be analyzed is limited to 10 (pg/g) or less. The acids employed for assessing the metallic impurity, the residual quantity thereof and the residual quantity of ions were also the equivalent class of reagents as described above. The addition of reagent, heating operation and pretreatment were all performed in a clean room of Class 1000 or less.

The instruments for analysis employed herein were as follows. The analysis by means of inductively coupled plasma-mass epectroscopy (ICP-MS) was performed using SPQ9000 (Seiko Instruments Co., Ltd.) or Plasma Trace 2 (Micromass Co., Ltd.). On the other hand, the analysis by means of graphite furnace atomic absorption spectroscopy (ETAAS) was performed using 5100ZL (Perkin-Elmer Co., Ltd.). The analysis by means of ion chromatography was performed using DX-100 (Dionex Co., Ltd.).

### EXAMPLE 1

The residue, in the analytical vessel, of the elements to be analyzed, i.e. Al, Zr, Zn, Cu, Fe, Cr and Mg, was assessed as follows.

(Experiment 1)

High-purity Al, Zr, Zn, Cu, Fe, Cr and Mg each 1 g in quantity were respectively placed in a glassy carbon vessel (Vessel (A): 100 mL in capacity) and then, 20 mL of aqua regia was introduced into the vessel. The resultant solution was heated for 2 hours at a temperature of 100° C. and washed with pure water. The vessel (A) was immersed in 0.1 mol/L solution of nitric acid for 4 hours, after which the quantity of elements in the nitric acid was quantified by means of ICP-MS method and the quantities of residual elements in the vessel (A) were respectively measured (Experiment 1-1).

Then, the same procedure as executed in Experiment 1-1 was repeated twice to assess the residual elements in the vessel (A) in the same manner as in Experiment 1-1 (Experiments 1-2 and 1-3). The results thus obtained are shown in the following Tables 2-4.

(Comparative Experiments 1-1 to 4-3)

Molded articles of Nippon Bulker Kogyo Co., Ltd. (Comparative Experiment 1: 30 mm in diameter, 7 mm in thickness and 300 μm in particle diameter of raw powder; Comparative Experiment 2: 20 μm in particle diameter of raw powder; Comparative Experiment 3: 300 μm in particle diameter of raw powder and modified PTFE raw powder; and Comparative Experiment 4: 20 μm in particle diameter of raw powder and modified PTFE raw powder) were employed. The method of assessing the quantity of residual metal elements and the method of quantifying the eluted substances were the same as those employed in Experiment 2. The results thus obtained are also shown in the following Tables 2-4.

TABLE 2
(First time)

(fg/cm²)

| | Experi- | Comp. | Comp. | Comp. | Comp. |
|---|---|---|---|---|---|
| | ment | Experiment | Experiment | Experiment | Experiment |
| | 1-1 | 1-1 | 2-1 | 3-1 | 4-1 |
| Al | <100 | 30,000 | 35,000 | 28,000 | 45,000 |
| Zr | <100 | 50,000 | 40,000 | 40,000 | 38,000 |
| Zn | <100 | 20,000 | 30,000 | 16,000 | 11,000 |
| Cu | <100 | 10,000 | 15,000 | 50,000 | 50,000 |
| Fe | <100 | 30,000 | 20,000 | 20,000 | 30,000 |
| Cr | <100 | 20,000 | 40,000 | 14,000 | 28,000 |
| Mg | <100 | 10,000 | 20,000 | 30,000 | 60,000 |
| Total | 0 | 170,000 | 200,000 | 198,000 | 262,000 |

TABLE 3
(Second time)

(fg/cm²)

| | Experi- | Comp. | Comp. | Comp. | Comp. |
|---|---|---|---|---|---|
| | ment | Experiment | Experiment | Experiment | Experiment |
| | 1-2 | 1-2 | 2-2 | 3-2 | 4-2 |
| Al | <100 | 5,000 | 2,900 | 5,600 | 3,100 |
| Zr | <100 | 12,000 | 3,200 | 1,100 | 2,000 |
| Zn | <100 | 4,000 | 3,000 | 3,900 | 3,700 |
| Cu | <100 | 7,000 | 7,500 | 4,700 | 2,500 |
| Fe | <100 | 8,000 | 12,000 | 2,900 | 1,700 |
| Cr | <100 | 10,000 | 3,000 | 3,800 | 2,900 |
| Mg | <100 | 3,000 | 1,800 | 2,700 | 3,700 |
| Total | 0 | 49,000 | 33,400 | 24,700 | 19,600 |

TABLE 4
(Third time)

(fg/cm²)

| | Experi- | Comp. | Comp. | Comp. | Comp. |
|---|---|---|---|---|---|
| | ment | Experiment | Experiment | Experiment | Experiment |
| | 1-3 | 1-3 | 2-3 | 3-3 | 4-3 |
| Al | <100 | 380 | 460 | 590 | 840 |
| Zr | <100 | 1,000 | 850 | 320 | 630 |
| Zn | <100 | 2,700 | 1,200 | 250 | 1,300 |
| Cu | <100 | 320 | 760 | 230 | 500 |
| Fe | <100 | 560 | 560 | 700 | 860 |
| Cr | <100 | 230 | 280 | 400 | 320 |
| Mg | <100 | 740 | 460 | 300 | 900 |
| Total | 0 | 5,930 | 4,570 | 2,790 | 5,350 |

As apparent from above Tables 2-4, the quantity detected of each of the analyzing elements eluted from the glassy carbon vessels (vessel [A]) in Experiments 1-1 to 1-3 was confined to 100 fg/cm² or less even after the repeated measurements, thereby making it possible to confirm that the analyzing elements were not diffused into the interior of the analytical vessel.

On the other hand, in the cases of the PTFE vessels and the modified PTFE vessels in Comparative Experiments 1-1 to 4-3, an elution of 230-50000 fg/cm² was continuously detected, thus confirming the diffusion of analyzing elements into the interior of vessel in the first employment thereof.

It will be recognized from these results that it was possible, through the employment of the vessel (A), to minimize the quantity of residual metal elements to be analyzed, and that the vessel (A) was provided with satisfactory characteristics which were suited for use as analytical vessel. Therefore, since not only the diffusion of impurities over the surface of vessel but also the diffusion of impurities into the interior of vessel could be extremely minimized in the case of the vessel (A), it was possible to obviate any complex process such as acid-washing treatment.

### EXAMPLE 2

The residue, in the analytical vessel, of the elements to be analyzed, i.e., K and Na, was assessed as follows.

(Experiment 2)

Potassium hydroxide and sodium hydroxide each 1 g in quantity were respectively placed in a glassy carbon vessel (Vessel (A): 100 mL in capacity) and then, 20 mL of pure water was introduced into the vessel. The resultant solution was heated for 2 hours at a temperature of 100° C. and washed with pure water. The vessel (A) was immersed in pure water for 4 hours, after which the quantity of K and Na in the pure water was quantified by means of atomic absorption spectrophotometry (hereinafter referred to as AAS) and the quantities of elements eluted from the vessel (A) were respectively measured (Experiment 2-1).

Then, the same procedure as executed in Experiment 2-1 was repeated twice to assess the residual elements in the vessel (A) in the same manner as in Experiment 2-1 (Experiments 2-2 and 2-3). The results thus obtained are shown in the following Tables 5-7.

(Comparative Experiments 5-1 to 8-3)

Molded articles of Nippon Bulker Kogyo Co., Ltd. (Comparative Experiment 5: 30 mm in diameter, 7 mm in thickness and 300 μm in particle diameter of raw powder; Comparative Experiment 6: 20 μm in particle diameter of raw powder; Comparative Experiment 7: 300 μm in particle diameter of raw powder and modified PTFE raw powder; and Comparative Experiment 8: 20 μm in particle diameter of raw powder and new-PTFE raw powder) were employed. The method of assessing the quantity of residual K and Na and the method of quantifying the eluted substances were the same as those employed in Experiment 2. The results thus obtained are shown in the following Tables 5-7.

TABLE 5
(First time)

(fg/cm²)

| | Experi- | Comp. | Comp. | Comp. | Comp. |
|---|---|---|---|---|---|
| | ment | Experiment | Experiment | Experiment | Experiment |
| | 2-1 | 5-1 | 6-1 | 7-1 | 8-1 |
| Na | <100 | 60,000 | 80,000 | 30,000 | 40,000 |
| K | <100 | 40,000 | 70,000 | 30,000 | 45,000 |
| Total | 0 | 100,000 | 150,000 | 60,000 | 85,000 |

TABLE 6

| | |
|---|---|
| (Second time) | (fg/cm²) |

| | Experiment | Comp. | Comp. | Comp. | Comp. |
|---|---|---|---|---|---|
| | 2-2 | Experiment 5-2 | Experiment 6-2 | Experiment 7-2 | Experiment 8-2 |
| Na | <100 | 4,500 | 6,700 | 2,900 | 5,800 |
| K | <100 | 3,200 | 5,400 | 2,700 | 3,300 |
| Total | 0 | 7,700 | 12,100 | 5,600 | 9,100 |

TABLE 7

| | |
|---|---|
| (Third time) | (fg/cm²) |

| | Experiment | Comp. | Comp. | Comp. | Comp. |
|---|---|---|---|---|---|
| | 2-3 | Experiment 5-3 | Experiment 6-3 | Experiment 7-3 | Experiment 8-3 |
| Na | <100 | 2,100 | 1,400 | 780 | 680 |
| K | <100 | 1,700 | 1,900 | 970 | 570 |
| Total | 0 | 3,800 | 3,300 | 1,750 | 1,250 |

As apparent from above Tables 5-7, the quantity detected of K and Na eluted from the glassy carbon vessels (vessel (A)) in Experiments 2-1 to 2-3 was confined to 100 fg/cm² or less even after the repeated measurements, thereby making it possible to confirm that K and Na were not diffused into the interior of the analytical vessel.

On the other hand, in the cases of the PTFE molded article, an elution of 570-80000 fg/cm² of K and Na was continuously detected, thus confirming the diffusion of K and Na into the interior of vessel in the initial employment thereof.

It will be apparent that the glassy carbon vessel (vessel [A]) according to this example was capable of exhibiting sufficient effects on an alkaline solution containing K, Na, etc., as well, thus exhibiting sufficient properties for use as an analytical vessel.

### EXAMPLE 3

The residue, in the analytical vessel, of chloride ions, nitrate ions, bromide ions, sulfate ions and fluoride ions was assessed as follows.

(Experiment 3)

20 mL of a mixed solution containing chloride ion, nitrate ion, bromide ion, sulfate ion and fluoride ion each at a concentration of 50 g/L was placed in a glassy carbon vessel (Vessel [A]: 100 mL in capacity). Then, the vessel (A) was placed in a stainless steel outer casing and, after the outer casing was capped, the mixed solution was heated for 4 hours in a thermostatic oven heated to a temperature of 180° C.

After being cooled, the vessel (A) was immersed in pure water for 4 hours, after which the quantity of chloride ions, nitrate ions, bromide ions, sulfate ions and fluoride ions eluted from the vessel (A) was quantified by means of ion chromatography and the quantities of ions remained in the vessel (A) were respectively measured (Experiment 3-1).

Then, the same procedure as executed in Experiment 3-1 was repeated twice to assess the residual ions in the vessel (A) in the same manner as in Experiment 2-1 (Experiments 3-2 and 3-3). The results thus obtained are shown in the following Tables 8-10.

(Comparative Experiments 9-1 to 12-3)

Molded articles of Nippon Bulker Kogyo Co., Ltd. (Comparative Experiment 9: 30 mm in diameter, 7 mm in thickness and 300 μm in particle diameter of raw powder; Comparative Experiment 10: 20 μm in particle diameter of raw powder; Comparative Experiment 11: 300 μm in particle diameter of raw powder and modified PTFE raw powder; and Comparative Experiment 12: 20 μm in particle diameter of raw powder and new-PTFE raw powder) were employed. The method of assessing the quantity of residual ions and the method of quantifying the eluted substances were the same as those employed in Experiment 3. The results thus obtained are shown in the following Tables 8-10.

TABLE 8
(First time)

(fg/cm²)

| | Experi- | Comp. | Comp. | Comp. | Comp. |
|---|---|---|---|---|---|
| | ment | Experiment | Experiment | Experiment | Experiment |
| | 3-1 | 9-1 | 10-1 | 11-1 | 12-1 |
| Cl | <10 | 23,000 | 40,000 | 60,000 | 60,000 |
| NO₃ | <10 | 500,000 | 20,000 | 3,000 | 70,000 |
| Br | <10 | 40,000 | 10,000 | 4,000 | 30,000 |
| SO₄ | <10 | 30,000 | 10,000 | 2,000 | 50,000 |
| F | <10 | 20,000 | 10,000 | 2,000 | 20,000 |
| Total | 0 | 613,000 | 90,000 | 71,000 | 230,000 |

Note:
Cl . . . Chloride ions;
NO₃ . . . Nitrate ions;
Br . . . Bromide ions;
SO₄ . . . Sulfate ions;
F . . . Fluoride ions.

TABLE 9
(Second time)

(fg/cm²)

| | Experi- | Comp. | Comp. | Comp. | Comp. |
|---|---|---|---|---|---|
| | ment | Experiment | Experiment | Experiment | Experiment |
| | 3-2 | 9-2 | 10-2 | 11-2 | 12-2 |
| Cl | <10 | 15,000 | 18,000 | 30,000 | 43,000 |
| NO₃ | <10 | 5,600 | 3,200 | 2,200 | 6,700 |
| Br | <10 | 3,800 | 4,500 | 2,900 | 3,300 |
| SO₄ | <10 | 2,400 | 3,300 | 800 | 4,300 |
| F | <10 | 1,700 | 1,200 | 900 | 1,700 |
| Total | 0 | 28,500 | 30,200 | 36,800 | 59,000 |

TABLE 10
(Third time)

(fg/cm²)

| | Experi- | Comp. | Comp. | Comp. | Comp. |
|---|---|---|---|---|---|
| | ment | Experiment | Experiment | Experiment | Experiment |
| | 3-3 | 9-3 | 10-3 | 11-3 | 12-3 |
| Cl | <10 | 7,500 | 9,500 | 1,400 | 5,600 |
| NO₃ | <10 | 1,800 | 600 | 1,200 | 340 |
| Br | <10 | 1,200 | 430 | 1,700 | 1,900 |
| SO₄ | <10 | 900 | 1,100 | 500 | 3,600 |
| F | <10 | 900 | 700 | 600 | 700 |
| Total | 0 | 12,300 | 12,330 | 5,400 | 12,140 |

As apparent from above Tables 8-10, the quantity detected of anionic components eluted from the vessel (A) in Experiments 3-1 to 3-3 was confined to 10 pg/cm² or less, thereby making it possible to confirm that ions were not diffused into the interior of the analytical vessel as in the cases of metal elements (Examples 1 and 2).

On the other hand, in the cases of the PTFE molded article in Experiments 9-1 to 12-3, an elution of 340-500000 pg/cm² of anions was continuously detected, thus confirming the diffusion of anions into the interior of vessel. It will be clear that the glassy carbon vessel was capable of exhibiting sufficient effects even against the anions.

When the quantity of metallic impurities contained in a semiconductor element for instance is to be measured by means of ICP-MS, if chloride ions, bromide ions, sulfate ions or fluoride ions co-exist in addition to argon to be employed as a plasma gas, a spectral interference to the metallic impurities is caused to generate due to the formation of each of the molecular ions, giving a great influence on the measured values.

In the case of the conventional analytical vessel, it is required, depending on the kind of element to be analyzed, to change the kind of acid to be employed for washing and to further perform washing for minimizing, as much as possible, the quantity of co-existing chloride ions, bromide ions and sulfate ions. However, in the case of the glassy carbon vessel (Vessel [A]) according to this example, since it is possible to substantially prevent the generation of residual acid irrespective of kinds of acid to be employed for washing, it is possible to perform acid washing in conformity with the kind of component to be analyzed.

### EXAMPLE 4

The elution of elements to be analyzed, i.e. Fe, K, Na, Zn, Cu, Cr, Al, B, Mg, K and Na all originally included in the vessels (A) and (B), was assessed as follows.

(Experiments 4 and 5)

The measurement of elements being analyzed and eluted from the glassy carbon vessels (vessel [A] having a capacity of 100 mL, and vessel [B] having a capacity of 100 mL) was performed as follows.

10 mL of a mixed solution consisted of 30% nitric acid:25% hydrofluoric acid at a ratio of 1:1 was placed in these vessel (A) and vessel (B) and heated for 2 hours at a temperature of 100° C. Subsequently, 200 μL of 1% solution of sulfuric acid was introduced into these vessels and heated until the white smoke of sulfuric acid was generated, thus concentrating the solution.

After being permitted to cool, pure water was added to the concentrated solution until the volume of the solution becomes 0.5 mL. This dilute solution was then subjected to analysis by means of ICP-MS for the analysis of Fe, K, Na, Zn, Cu, Cr, Al, B and Mg, and by means of ETAAS for the analysis of K, Na and Zn, thereby measuring the quantity eluted of these elements. The results thus obtained are shown in the following Table 11.

(Comparative Experiments 13 to 16)

Vessels of Nippon Bulker Kogyo Co., Ltd. (Comparative Experiment 13: 300 μm in particle diameter; Comparative Experiment 14: 20 μm in particle diameter of raw powder; Comparative Experiment 15: 300 μm in particle diameter and modified PTFE raw powder; and Comparative Experiment 16: 20 μm in particle diameter and modified PTFE raw powder) were employed. The method of assessing the quantity of eluted elements was the same as that employed in Experiments 4 and 5. The results thus obtained are shown in the following Table 11.

TABLE 11
(fg/cm²)

| | | | | | Comp. | Comp. |
|---|---|---|---|---|---|---|
| | Experi- | Experi- | Comp. | Comp. | Experi- | Experi- |
| | ment | ment | Experiment | Experiment | ment | ment |
| | 4 | 5 | 13 | 14 | 15 | 16 |
| Fe | <100 | 200 | 500 | 500 | 3,000 | 2,000 |
| K | <100 | <100 | 200 | <100 | <100 | 1,000 |
| Na | <100 | <100 | <100 | 800 | 1,000 | 200 |
| Zn | <100 | <100 | 300 | 100 | 500 | <100 |
| Cu | <100 | <100 | <100 | <100 | <100 | <100 |
| Cr | <100 | <100 | <100 | <100 | <100 | <100 |
| Al | <100 | 300 | 1,000 | 3,000 | 800 | 300 |
| B | <100 | <100 | <100 | <100 | <100 | <100 |
| Mg | <100 | <100 | 300 | 3,000 | 3,000 | 300 |
| Total | 0 | 500 | 2,300 | 7,400 | 8,300 | 3,800 |

As apparent from above Table 11, the quantity eluted of Fe, K, Na, Zn, Cu, Cr, Al, B and Mg in Experiment 4 was confined to 100 fg/cm² or less, and in Experiment 5 also, the quantity eluted of these elements was as small as half to 1/10 of the PTFE molded articles of Comparative Experiments 13-16. Further, since the quantity eluted of these elements in Experiments 4 and 5 was confined to very low levels, it will be recognized that the vessel (A) and the vessel (B) were effective for use as an analytical vessel.

Accordingly, when the glassy carbon vessels (vessel [A] and vessel [B]) described in this example are employed as an analytical vessel for assessing the residual quantity, eluted quantity and content of metallic component on the surface or in the interior of sample by means of ICP-MS or ETAAS, it would become possible to greatly minimize the noise that may become a great issue in the analysis of metallic impurities.

Further, since the glassy carbon is higher in thermal conductivity as compared with PTFE, it would be possible to reduce the time required for the concentration of sample solution to half as compared with PTFE. In the case of PTFE, depending on the heating temperature and the kind of solution, there has been frequently recognized the generation of bubbles from the bottom of vessel on the occasion of concentration, thus giving rise to the scattering of sample solution due to bumping phenomenon. Whereas, in the case of the glassy carbon vessel, there is little possibility of generating bubbles even if the concentration of solution is performed at high temperatures, thus making it possible to suppress the scattering of sample solution on the occasion of concentration of solution, thus indicating enhanced safety during the use of the vessel.

1. An analytical vessel for analyzing trace elements, which is formed of glassy carbon produced through carbonization of a resin composition.

2. The analytical vessel according claim 1, wherein the resin composition is a thermosetting resin selected from the group consisting of a phenol resin, polyimide resin, epoxy resin, furan resin, and a mixture thereof.

3. The analytical vessel according claim 2, wherein the resin composition contains at least one element selected from the group consisting of Al, B, Ca, Cr, Cu, Fe, Ge, K, Na, Ni, Si, Ti, the content thereof being confined to 0.1 μg/g or less.

4. The analytical vessel according claim 1, wherein the analytical vessel is formed through carbonization of the resin composition.

5. The analytical vessel according claim 1, wherein the analytical vessel is formed through carbonization and molding of the resin composition.

6. The analytical vessel according claim 1, wherein the analytical vessel is mirror-polished.

7. The analytical vessel according claim 1, which contains residual metal element of 100 fg/cm² or less, remained in the vessel, after a solution containing at least one metal element selected from the group consisting of Al, Cr, Cu, Fe, Mg, Zn and Zr at a concentration of 5% or less is placed in the vessel at a temperature ranging from 20 to 200° C. and then taken out of the vessel, and the vessel is washed.

8. The analytical vessel according claim 1, which contains with residual alkaline metal of 100 fg/cm² or less, remained in the vessel, after at least one alkaline solution selected from potassium hydroxide and sodium hydroxide each 5% or less in concentration is placed in the vessel at a temperature ranging from 20 to 200° C. and then taken out of the vessel, and the vessel is washed.

9. The analytical vessel according claim 1, which contains residual ion of 1 ng/cm² or less, said residual ion being at least one selected from the group consisting of chloride ion, nitrate ion, bromide ion, sulfate ion and fluoride ion, and remained in the vessel, after an acid solution containing one acid selected from the group consisting of hydrochloric acid, nitric acid, hydrobromic acid, sulfuric acid and hydrofluoric acid at a concentration of 5% or less is placed in the vessel at a temperature ranging from 20 to 200° C. and then taken out of the vessel, and the vessel is washed.

10. The analytical vessel according claim 1, which contains an element of 100 fg/cm² or less, said element being at least one element selected from the group consisting of Al, B, Ca, Co, Cr, Cu, Fe, Ge, K, Mg, Mo, Na, Ni, Pb, Si, Sr, Ti, Zn and Zr, and eluted from the vessel, after at least one acid selected from the group consisting of hydrochloric acid, nitric acid, hydrobromic acid, sulfuric acid and hydrofluoric acid is placed in the vessel and then heated.

11. A method of analyzing trace elements, which comprises:
preparing an analytical vessel containing an assay sample, the vessel made of glassy carbon produced through carbonization of a resin composition;
introducing a solution which is capable of dissolving the assay sample into the analytical vessel to thereby dissolve the assay sample, thus obtaining a sample solution; and
measuring trace elements dissolved in the sample solution.

12. The method of analyzing trace elements according to claim 11, wherein the measurement of the trace elements is performed by means of inductively coupled plasma-mass epectroscopy or graphite furnace atomic absorption spectroscopy.

13. The method of analyzing trace elements according to claim 11, wherein the analytical vessel contains residual metal element of 100 fg/cm² or less, remained in the vessel, after a solution containing at least one metal element selected from the group consisting of Al, Cr, Cu, Fe, Mg, Zn and Zr at a concentration of 5% or less is placed in the vessel at a temperature ranging from 20 to 200° C. and then taken out of the vessel, and the vessel is washed.

14. The method of analyzing trace elements according to claim 11, wherein the analytical vessel contains residual alkaline metal of 100 fg/cm² or less, eluted and remained in the vessel, after at least one alkaline solution selected from potassium hydroxide and sodium hydroxide each 5% or less in concentration is placed in the vessel at a temperature ranging from 20 to 200° C. and taken out of the vessel, and the vessel is washed.

15. The method of analyzing trace elements according to claim 11, wherein the analytical vessel contains at least one residual ion of 1 ng/cm² or less, said residual ion being selected from the group consisting of chloride ion, nitrate ion, bromide ion, sulfate ion and fluoride ion, and remained in the vessel, after an acid solution containing one acid selected from the group consisting of hydrochloric acid, nitric acid, hydrobromic acid, sulfuric acid and hydrofluoric acid at a concentration of 5% or less is placed in the vessel at a temperature ranging from 20 to 200° C. and then taken out of the vessel, and the vessel is washed.

16. The method of analyzing trace elements according to claim 11, wherein the analytical vessel contains an element of 100 fg/cm² or less, said element being selected from the group consisting of Al, B, Ca, Co, Cr, Cu, Fe, Ge, K, Mg, Mo, Na, Ni, Pb, Si, Sr, Ti, Zn and Zr and eluted from the vessel, after at least one acid selected from the group consisting of hydrochloric acid, nitric acid, hydrobromic acid, sulfuric acid and hydrofluoric acid is placed in the vessel and then heated.

17. The method of analyzing trace elements according to claim 16, wherein the solution for decomposing the assay sample is at least one acid solution selected from the group consisting of hydrochloric acid, nitric acid, hydrobromic acid, sulfuric acid and hydrofluoric acid, and the trace elements dissolved in the solution is at least one element selected from the group consisting of Al, B, Ca, Co, Cr, Cu, Fe, Ge, K, Mg, Mo, Na, Ni, Pb, Si, Sr, Ti, Zn and Zr.
